(19) United States
(12) Patent Application Publication
(10) Pub. No.: US 2017/0168405 A1
(43) Pub. Date: Jun. 15, 2017

(54) ELECTROPHOTOGRAPHIC MEMBER, METHOD FOR MANUFACTURING SAME, AND ELECTROPHOTOGRAPHIC IMAGE FORMING APPARATUS

(71) Applicant: CANON KABUSHIKI KAISHA, Tokyo (JP)

(72) Inventors: Kouichi Uchida, Yokohama-shi (JP); Eiichi Hamana, Inagi-shi (JP); Noriaki Egawa, Komae-shi (JP)

(21) Appl. No.: 15/373,336

(22) Filed: Dec. 8, 2016

(30) Foreign Application Priority Data
Dec. 10, 2015 (JP) 2015-241121

(51) Int. Cl. B32B 9/04

(52) U.S. Cl. CPC G03G 5/08

(57) ABSTRACT

An electrophotographic member capable of maintaining stable quality regardless of environment in forming a surface layer is provided. The electrophotographic member includes a base layer and a surface layer. The surface layer includes a heteroaggregate of inorganic oxide particles, electro-conductive metal oxide particles different from the inorganic oxide particles, and an ionic liquid.

### BACKGROUND OF THE INVENTION

Field of the Invention

The present disclosure relates to an electrophotographic member like an electrophotographic belt, which is used as a conveyance transfer belt or an intermediate transfer belt in an electrophotographic image forming apparatus, and a photosensitive member. The present disclosure also relates to an electrophotographic image forming apparatus.

Description of the Related Art

Electrophotographic image forming apparatuses use electrophotographic members, such as a conveyance transfer belt which conveys a transfer material, an intermediate transfer belt which temporarily holds a transferred toner image, and a photosensitive drum which forms an electrostatic latent image. Such electrophotographic members are in contact with and slide over other members in the electrophotographic image forming apparatuses. If an electrophotographic member has too smooth a surface, the electrophotographic member can make close contact with and adhere to another member. As employed herein, the phenomenon that an electrophotographic member adheres to another member may hereinafter be referred to as a “blocking phenomenon.”

If an electrophotographic belt adheres to a photosensitive member, the running stability of the photosensitive drum and the electrophotographic belt can be impaired. If an electrophotographic belt adheres to a cleaning blade, the cleaning blade can be turned over to cause a cleaning failure of the electrophotographic belt. To solve such issues, Japanese Patent Application Laid-Open No. 2004-182382 discusses roughening of the surface of an electrophotographic belt.

Japanese Patent Application Laid-Open No. 2007-31625 discusses a method for roughening the surface of an electrophotographic belt. The method includes forming a surface layer containing particles having particle diameters of approximately 0.1 to 3 μm that protrusions derived from the particles are formed on the surface of the surface layer.

Japanese Patent Application Laid-Open No. 2014-146024 discusses a surface layer of an electrophotographic belt on which protrusions are formed by heteroaggregation of two different types of oxide particles. The formation of such protrusions can suppress the occurrence of close contact and blocking to other members, and makes image defects resulting from singular protrusions less likely to occur.

### SUMMARY OF THE INVENTION

An aspect of the present disclosure is directed to the provision of an electrophotographic member capable of maintaining stable quality even under various production environments, and a method for manufacturing the same. Another aspect of the present disclosure is directed to the provision of an electrophotographic image forming apparatus that can stably form a high-quality electrophotographic image.

According to an aspect of the present disclosure, an electrophotographic member includes a base layer and a surface layer, wherein the surface layer contains a heteroaggregate of inorganic oxide particles, electro-conductive metal oxide particles different from the inorganic oxide particles, and an ionic liquid.

According to another aspect of the present disclosure, a method for manufacturing an electrophotographic member, the electrophotographic member including a base layer and a surface layer on the base layer, or a base layer, an elastic layer on the base layer, and a surface layer on the elastic layer, the method includes forming a layer of a curable composition on the base layer including an ionic liquid or forming the layer of the curable composition on the elastic layer including the ionic liquid, the curable composition including inorganic oxide particles and electro-conductive metal oxide particles different from the inorganic oxide particles, causing heteroaggregation of the inorganic oxide particles, the electro-conductive metal oxide particles, and the ionic liquid in the layer of the curable composition, and curing the layer of the curable composition to form the surface layer.

According to yet another aspect of the present disclosure, a method for manufacturing an electrophotographic member including a base layer and a surface layer includes causing heteroaggregation of inorganic oxide particles, electro-conductive metal oxide particles different from the inorganic oxide particles, and an ionic liquid in a curable composition including the inorganic oxide particles, the electro-conductive metal oxide particles, and the ionic liquid, and curing a layer of the curable composition.

According to yet another aspect of the present disclosure, an electrophotographic apparatus includes an electrophotographic photosensitive member and a transfer unit configured to transfer a toner image formed on the electrophotographic photosensitive member to a transfer material, wherein the transfer unit includes the foregoing electrophotographic member as an intermediate transfer belt.

Further features will become apparent from the following description of exemplary embodiments with reference to the attached drawings.

### BRIEF DESCRIPTION OF THE DRAWINGS

FIG. 1 is a schematic sectional view illustrating an example embodiment of an electrophotographic belt.

FIG. 2 is a schematic sectional view illustrating another example embodiment of the electrophotographic belt.

FIG. 3 is a schematic diagram illustrating a stretch blow molding machine.

FIG. 4 is an explanatory diagram illustrating an example embodiment of an electrophotographic apparatus.

FIG. 5 is a schematic diagram illustrating an example embodiment of a jig for evaluating adhesiveness between an electrophotographic belt and another member.

### DESCRIPTION OF THE EMBODIMENTS

Upon investigation, it has been revealed that the surface roughness of the electrophotographic belts according to Japanese Patent Application Laid-Open No. 2014-146024 may fluctuate depending on an absolute humidity of an atmosphere for forming surface layers thereof.

As production bases of electrophotographic image forming apparatuses become more and more global in recent years, production bases of various members used in the electrophotographic image forming apparatuses are also being distributed in various parts of the world. It is costly to maintain the environments of the various production bases constantly the same. Thus, there is a need to develop an electrophotographic member capable of maintaining stable quality even under various environments.

As for the reason why the surface roughness of the electrophotographic belts according to Japanese Patent Application Laid-Open No. 2014-146024 varies depending on the environment, or more specifically, the absolute humidity of the atmosphere for forming the surface layers, one may consider the following.

The surface roughening of the surface layers according to Japanese Patent Application Laid-Open No. 2014-146024 is achieved by forming of protrusions on the surfaces of the surface layers. The protrusions are derived from heteroaggregates of inorganic oxide particles and electro-conductive metal oxide particles different from the inorganic oxide particles.

Such heteroaggregates can be formed in the presence of alkali metal ions. For example, a layer of a curable composition obtained by dispersing the inorganic oxide particles and the electro-conductive metal oxide particles in a solvent is formed on a base layer containing perfluoroalkyl sulfonimide alkali metal salt. As a result, alkali metal ions migrate to the layer of the curable composition between immediately after the formation of the layer of the curable composition to volatilization of the solvent from the layer of the curable composition.

The heteroaggregation is considered to be caused by the following mechanism.

The inorganic oxide particles and the electro-conductive metal oxide particles in the curable composition have negative charges (zeta potentials), and both the particles maintain a stable dispersed state.

If the layer of the curable composition is formed on the base layer of an electrophotographic member, alkali metal ions included in the base layer of the electrophotographic member migrate to the layer of the curable composition, and the concentration of the alkali metal ions in the layer increases. At the same time, the volatilization of the solvent causes a further increase in the concentration of the alkali metal ions in the layer. The alkali metal ions are coordinated with and absorbed to the electro-conductive metal oxide particles, whereby the charge (zeta potential) of the electro-conductive metal oxide particles is inverted. This results in a state where the electro-conductive metal oxide particles are positively charged and the inorganic oxide particles are negatively charged, and the particles form heteroaggregates in the layer of the curable composition.

The resulting heteroaggregates roughen the surface of the electrophotographic member.

In the process of forming the heteroaggregates, the coordination and absorption of the alkali metal ions are considered to occur both in the electro-conductive metal oxide particles and the inorganic oxide particles. As compared to the charge (zeta potential) of the inorganic oxide particles, that of the electro-conductive metal oxide particles is easy to invert. This promotes the generation of the heteroaggregates.

The ionic bonding force of alkali metal salts, such as the perfluoroalkyl sulfonimide alkali metal salt contained in the base layer, varies with the amount of water present. In other words, the degree of dissociation of the alkali metal salts varies with the absolute humidity. The present inventors have considered that the concentration of the alkali metal ions in the layer of the curable composition varies with the humidity of the environment in forming the surface layer, and thus the finally-formed heteroaggregates fluctuate in size.

Based on such a consideration, further investigation has shown that the foregoing issue can be solved by replacing the alkali metal salt for forming the heteroaggregates with an ionic liquid. More specifically, it has been found that by using cation components of the ionic liquid to cause heteroaggregation of the inorganic oxide particles and the electro-conductive metal oxide particles, an electrophotographic member can be obtained in which variations in the surface roughness are prevented or suppressed regardless of differences in the humidity of the atmosphere for forming the surface layer thereof. The reason is considered to be that the ionic liquid has extremely high ionic self-dissociability, and the ion concentrations are less susceptible to the ambient humidity.

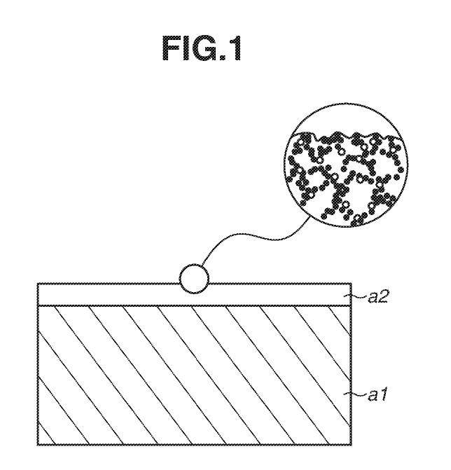

An example embodiment of an electrophotographic member will be described in detail below by using an electrophotographic belt as an example. The present invention is not limited to the following exemplary embodiment. FIG. 1 illustrates a conceptual sectional view of an example electrophotographic belt. The electrophotographic belt is a two-layer belt including an electrophotographic seamless belt base layer (base layer) a1 and a surface layer a2 which is formed by depositing a curable composition on the base layer a1.

The base layer a1 typically has a thickness of 10 μm or more and 500 μm or less, particularly 30 μm or more and 150 μm or less. The surface layer a2 having a thickness of 0.05 μm or more and 20 μm or less, particularly 0.1 μm or more and 5 μm or less, is suitably used.

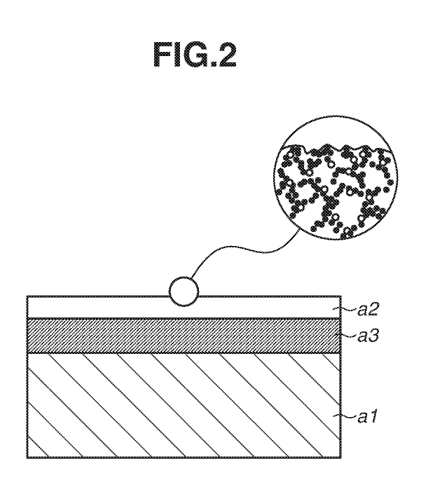

The electrophotographic belt may include another layer between the base layer a1 and the surface layer a2, inside the base layer a1, and/or on the surface layer a2. Examples include an electrophotographic belt of three-layer configuration illustrated in FIG. 2, including an elastic layer a3 between the base layer a1 and the surface layer a2.

### <<Surface Layer>>

The surface of the surface layer a2 is roughened by heteroaggregates of inorganic oxide particles, electro-conductive metal oxide particles different from the inorganic oxide particles, and an ionic liquid.

The surface of the surface layer a2 can have a ten-point average roughness (hereinafter, also referred to as “Rzjis”) of 0.3 μm or more and 0.7 μm or less. This can suppress occurrence of a blocking phenomenon in which the electrophotographic belt and other members block each other.

Heteroaggregates according to an aspect of the present disclosure can be quickly and stably generated from the inorganic oxide particles and the electro-conductive metal oxide particles different from the inorganic oxide particles in the presence of the ionic liquid.

The heteroaggregates can be generated in such a manner that the ionic liquid is included into the underlayer of the surface layer a2 of the electrophotographic belt, i.e., the base layer a1 or the elastic layer a3, so that the ionic liquid can migrate into the curable composition for forming the surface layer a2, and then the layer of the curable composition for forming the surface layer a2 is formed on the surface of the underlayer.

One method for including the ionic liquid into the underlayer of the surface layer a2 is to use the ionic liquid as one of the materials used to form the base layer a1 or the elastic layer a3. Another method is to apply a liquid containing the ionic liquid in advance to the surface of the base layer a1 or the elastic layer a3 on which the surface layer a2 is formed.

A method for forming the surface layer a2 will be described in detail below.

The curable composition for forming the surface layer a2 may contain the ionic liquid as one of its components. This, combined with the migration of the cation components of the ionic liquid from the underlayer, contributes to more efficient generation of the heteroaggregates.

Even if the underlayer does not contain the ionic liquid, the inclusion of the ionic liquid in the curable composition can increase the concentration of the ionic liquid in a coating film of the curable composition as the solvent evaporates from the coating film in a drying process of the coating film. The inorganic oxide particles, the electro-conductive metal oxide particles different from the inorganic oxide particles, and the ionic liquid then form heteroaggregates accordingly.

The curable composition for forming the surface layer a2 will initially be described.

### <Components of Curable Composition>

The components of the curable composition for forming the surface layer a2 are listed below.

### (a) Inorganic Oxide Particles:

The inorganic oxide particles can have an average primary particle diameter of 10 nm or more and 30 nm or less. Average primary particle diameters in such a range can easily achieve the foregoing surface roughness. In a case where an average primary particle diameter is more than 30 nm, a lot of singular protrusions may occur on the surface of the surface layer a2.

For stable dispersion in an organic solvent and for negative charging, the surfaces of the inorganic oxide particles can be alkyl-modified by using a silane coupling agent.

Examples of the inorganic oxide particles include known particles, such as silicon oxide particles, titanium oxide particles, yttrium oxide particles, aluminum oxide particles, zinc oxide particles, tin oxide particles, cerium oxide particles, iron oxide particles, copper oxide particles, and cobalt oxide particles, and complexes thereof.

The curable composition can be prepared by using a dispersion liquid that contains the foregoing inorganic oxide particles in a dispersed state.

Specifically, commercially available products, such as “SNOWTEX MEK-ST” (trade name, manufactured by Nissan Chemical Industries, Ltd.) and “OSCAL” (trade name, manufactured by JGC Corporation) may be used as a dispersion liquid containing silicon oxide particles in a dispersed state.

Commercially available products, such as “NanoTek” series (trade name, manufactured by C. I. Kasei Co., Ltd.) may be used as a dispersion liquid containing titanium oxide particles in a dispersed state and a dispersion liquid containing yttrium oxide particles in a dispersed state.

Of these, silicon oxide particles are the most suitable as the inorganic oxide particles in view of stable dispersion in an organic solvent and negative charging. Silicon oxide particles surface-treated with a silane coupling agent may be used.

### (b) Electro-Conductive Metal Oxide Particles:

Some electrophotographic belts need semiconductivity. In such a case, electro-conductive metal oxide particles can be used as the particles.

Examples of the electro-conductive metal oxide particles include zinc antimonate particles, gallium-doped zinc oxide particles, antimony-doped tin oxide particles, indium-doped tin oxide particles, and aluminum-doped zinc oxide particles. Of these, zinc antimonate particles are suitable in view of stable dispersion in an organic solvent, negative charging, and the absorption and coordination of cation component of the ionic liquid for positive inversion of charge.

The electro-conductive metal oxide particles can be treated with alkylamine for the sake of the stable dispersion in an organic solvent, the negative charging, and the absorption and coordination of cation components of the ionic liquid for positive inversion of charge. For example, a mixture of the electro-conductive metal oxide particles, 2-butanone, and tri-n-butylamine can be dispersed for the alkylamine treatment of the electro-conductive metal oxide particles.

The curable composition can be prepared by using a dispersion liquid containing the electro-conductive metal oxide particles in a dispersed state.

For example, commercially available products, such as “CELNAX CX-Z400K” (trade name, manufactured by Nissan Chemical Industries, Ltd.), may be used as a dispersion liquid containing zinc antimonate particles in a dispersed state. Commercial available products, such as “GZMMIBK-E12” (trade name, manufactured by C. I. Kasei Co., Ltd.), may be used as a dispersion liquid containing gallium-doped zinc oxide particles in a dispersed state. Commercially available products, such as “ATO (T-1)” (trade name, manufactured by Mitsubishi Materials Electronic Chemicals Co., Ltd.), may be used as a dispersion liquid containing antimony-doped tin oxide particles in a dispersed state.

The electro-conductive metal oxide particles can have an average primary particle diameter of 5 nm or more and 40 nm or less. Average primary particle diameters in such a range can suppress the occurrence of singular protrusions on the surface of the surface layer a2 of the electrophotographic member, and facilitate the provision of an electrophotographic member including an outer surface having a roughness Rzjis of 0.3 to 0.7 μm, formed by heteroaggregates with the inorganic oxide particles and the ionic liquid.

### (c) Acrylic Polymer:

A matrix resin of the surface layer a2 can contain an acrylic polymer that provides the surface layer a2 with high abrasion resistance and high hardness.

Monomers for forming the acrylic polymer are not limited in particular. Polyfunctional acrylic monomers can be used, because the surface layer a2 having even higher abrasion resistance and higher hardness can be obtained.

Specific examples of polyfunctional acrylate include the following:

Pentaerythritol tri(meth)acrylate, pentaerythritol tetra(meth)acrylate, trimethylolpropane tri(meth)acrylate, ethylene oxide (EO)-modified trimethylolpropane tri(meth)acrylate, propylene oxide (PO)-modified trimethylolpropane tri(meth)acrylate, dipentaerythritol penta and hexa(meth)acrylates, and EO-modified di and tri(meth)acrylate isocyanurates.

Of these, dipentaerythritol penta(meth)acrylate and dipentaerythritol hexa(meth)acrylate can be particularly suitably used.

To suppress contraction of the film of the curable composition during curing and to adjust the curable composition to a viscosity appropriate for application, two types or more of monomers selected from the foregoing monomer group may be used in appropriate combinations.

### (d) Solvent:

Specific examples of the solvent for stably dispersing or dissolving the foregoing components (a), (b), and (c), and a component (e) to be described below, may include the following:
Alcohols, such as methanol, ethanol, isopropanol, butanol, and octanol;
Ketones, such as acetone and cyclohexanone;
Esters, such as ethyl acetate, butyl acetate, ethyl lactate, γ-butylolactone, propylene glycol monomethyl ether acetate, and propylene glycol monoethyl ether acetate;
Ethers, such as ethylene glycol monomethyl ether and diethylene glycol monobutyl ether;
Aromatic hydrocarbons, such as benzene, toluene, and xylene; and
Amides, such as dimethylformamide, dimethylacetamide, and N-methylpyrrolidone.

Of these, methyl isobutyl ketone, methyl ethyl ketone, cyclohexanone, propylene glycol monomethyl ether acetate, propylene glycol monoethyl ether acetate, toluene, xylene, 2-butanone, or 4-methyl-2-pentanone can be suitably used since those solvents can dissolve the component (c) more easily and volatilize more quickly from the film of the curable composition.

To adjust the drying speed of the film of the curable composition and to adjust the curable composition to a viscosity appropriate for application, a plurality of solvents may be used in combination.

### (e) Ionic Liquid:

An ionic liquid may be added as a component (e) to the curable composition, on condition that the dispersibility of the components (a) and (b) in the curable composition will not be impaired.

If the base layer a1 or the elastic layer a3 contains the ionic liquid as much as needed to cause heteroaggregation of the components (a) and (b) in the curable composition formed on the surface of the base layer a1 or the surface of the elastic layer a3, the component (e) does not need to be added to the curable composition.

The ionic liquid serving as the component (e) refers to a salt that exists in a liquid form in a wide temperature range. The ionic liquid is a liquid including only ions, and if relatively large organic ions are used as ion species constituting the salt, the salt usually has a melting point of 100° C. or lower. There are many types of ionic liquids with various combinations of cation and anion species, which will be described below.

Imidazolium ions, pyridinium ions, and ammonium ions are typically used as the cation species included in the ionic liquid.

Examples of the imidazolium ions include the following:

1-Alkyl-3-methylimidazolium ions (RMI) (such as 1-ethyl-3-methylimidazolium ion (EMI), 1-butyl-3-methylimidazolium ion (BMI), and 1-hexyl-3-methylimidazolium ion (HMI)) represented by the following formula (1); and
1-Alkyl-2,3-dimethylimidazolium ions (RDMI) (such as 1-ethyl-2,3-dimethylimidazolium ion (EDMI), 1-butyl-2,3-dimethylimidazolium ion (BDMI), and 1-hexyl-2,3-dimethylimidazolium ion (HDMI)) represented by the following formula (2).

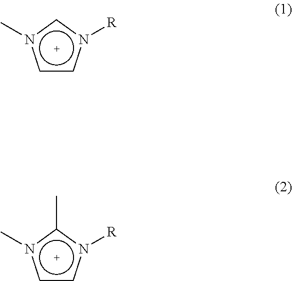

In formulas (1) and (2), R is an alkyl group with a carbon number of 1 to 8.

Examples of the pyridinium ions include the following:

1-Alkylpyridinium ions (RPy) (such as 1-ethylpyridinium ion (EtPy), 1-butylpyridinium ion (BuPy), and 1-hexylpyridinium (HexPy)) represented by the following formula (3); and
1-Alkyl-3-methylpyridinium ions (RMePy) (such as 1-ethyl-3-methylpyridinium ion (EtMePy) and 1-butyl-3-methylpyridinium ion (BuMePy)) represented by the following formula (4).

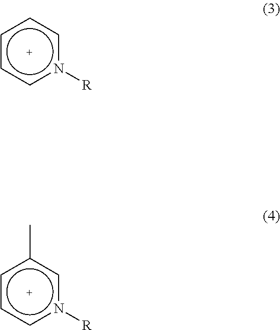

In formulas (3) and (4), R is an alkyl group with a carbon number of 1 to 8.

A lot of asymmetric quaternary ammonium salts are used as the ammonium ions. Examples include the following:
N,N,N-Trimethyl-N-propylammonium ion (TMPA) represented by the following formula (5);
N,N-Diethyl-N-methyl-N-(2-methoxyethyl)ammonium ion represented by the following formula (6);
1-Methyl-1-propylpyrrolidinium ion (P1.3) represented by the following formula (7);
1-Methyl-1-butylpyrrolidinium ion (P1.4) represented by the following formula (8);
N-Methyl-N-propylpyrrolidinium ion (PP1.3) represented by the following formula (9); and N,N,N-Tributyl-N-methylammonium ion.

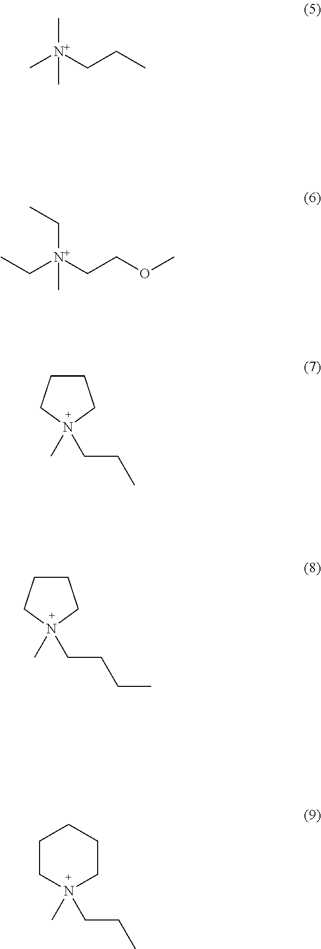

Inorganic ions and organic ions can be used as the anion species included in the ionic liquid. For the inorganic ions, Cl⁻, Br⁻, I⁻, BF₄⁻, PF₆⁻, and HSO₃⁻ are widely used.

Examples of the organic ions include the following:
Alkyl sulfate ions (such as methyl sulfate ion and ethyl sulfate ion) represented by the following formula (10);
Perfluoroalkyl sulfonate ions (such as trifluoromethane sulfonate ion (EF11), perfluoroethane sulfonate ion (EF21), perfluoropropane sulfonate ion (EF31), perfluorobutane sulfonate ion (EF41), perfluorohexane sulfonate ion (EF61), perfluorooctane sulfonate ion (EF81), and perfluorodecane sulfonate ion (EF101)) represented by the following formula (11); and
Perfluoroalkyl sulfonimide ions (such as bis(trifluoromethanesulfonyl)imide ion (N111), bis(perfluoroethanesulfonyl)imide ion (N221), bis(perfluoropropanesulfonyl)imide ion (N331), bis(perfluorobutanesulfonyl)imide ion (N441), trifluoromethanesulfonyl perfluoropropanesulfonyl imide ion (N131), and trifluoromethanesulfonyl perfluorobutanesulfonyl imide ion (N141)) represented by the following formula (12).

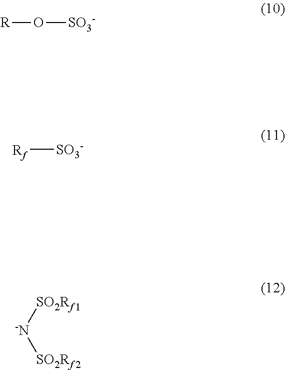

In formula (10), R is an alkyl group with a carbon number of 2 to 12. In formula (11), R_{f} is a perfluoroalkyl group with a carbon number of 2 to 12. In formula (12), R_{f1} and R_{f2} are respective independent perfluoroalkyl groups with a carbon number of 1 to 8.

The following components may be mixed into the curable composition if needed.

Radical Polymerization Initiator:

Examples of the radical polymerization initiator may include compounds that thermally generate active radical species (thermal polymerization initiators), and compounds that generate active radical species by radiation (light) irradiation (radiation (photo) polymerization initiators).

The radiation (photo) polymerization initiators are not limited in particular as long as the radiation (photo) polymerization initiators can be decomposed by light irradiation to generate radicals and initiate polymerization. Examples include acetophenone and acetophenone benzyl ketal.

The mixing amount of the radical polymerization initiator can be 0.01 to 10 parts by weight, favorably 0.1 to 5 parts by weight, with respect to 100 parts by weight of the (meth)acrylate compound. At a mixing amount of less than 0.01 parts by weight, the hardness of the cured article may be insufficient. Above 10 parts by weight, the cured article may fail to fully cure inside (lower layer).

Others:

If needed, other components may be added to the curable composition to an extent not impairing the effects disclosed herein. Examples include a polymerization inhibitor, a polymerization initiation auxiliary agent, a leveling agent, a wettability improving agent, a surface active agent, a plasticizer, an ultraviolet absorber, an antioxidant, an antistatic agent, an inorganic filler, and pigment.

### <Method for Preparing Curable Composition>

The curable composition contains the components (a) and (b) which are particulate substances, and the component (c) which often has high viscosity. The curable composition can be manufactured by the following method.

Initially, prepare a slurry formed by dispersing the component (a) in a solvent, a slurry formed by dispersing the component (b) in a solvent, and a solution formed by dissolving the component (c) in a solvent.

Next, put the slurries, the solution, the component (d), a polymerization initiator, and, if necessary, the component (e) and/or other components into a container with an agitator. Agitate the contents at normal temperature (a temperature of 25° C.) for a predetermined time (for example, 30 minutes) to prepare the curable composition.

### <Method for Manufacturing Electrophotographic Member>

### <<A>>

A method for manufacturing the electrophotographic member illustrated in FIG. 1, including the base layer a1 and the surface layer a2 on the base layer a1, will initially be described.

### (A-1) Fabrication of Base Layer a1 Including Ionic Liquid

### <Components of Base Layer>

The components of the base layer a1 are listed below.

### (f) Resin:

The resin used to form the base layer a1 is not limited in particular. Specific examples of the resin include polyimide (PI), polyamide-imide (PAI), polypropylene (PP), polyethylene (PE), polyamide (PA), polylactic acid (PLLA), polyethylene terephthalate (PET), polyethylene naphthalate (PEN), polyphenylene sulfide (PPS), polyether ether ketone (PEEK), polycarbonate (PC), and fluorocarbon resin (polyvinylidene difluoride (PVDF)). Two types or more of these resins may be mixed for use. Of these resins, polyethylene naphthalate (PEN) having high strength and flexibility is suitable.

### (e) Ionic Liquid:

The base layer a1 contains the ionic liquid so that the ionic liquid migrates into the coating film of the curable composition for forming the surface layer a2 in the drying process of the coating film formed on the surface of the base layer a1.

The amount of the ionic liquid added to the resin can be appropriately adjusted according to the content of the inorganic oxide particles and the electro-conductive metal oxide particles in the surface layer a2. For example, the ionic liquid as much as 0.01 parts or more and 10 parts or less by weight can be added to 100 parts by weight of the resin according to the foregoing component (f).

As another method for forming the base layer a1 including the ionic liquid, a base layer containing the resin may be formed in advance, and a liquid containing the ionic liquid may be applied to the surface of the base layer on the side where the surface layer a2 is formed.

The base layer a1 may contain the following other components as appropriate:

Ionic electro-conductive agents (such as a polymer ionic electro-conductive agent and a surface active agent), electro-conductive polymers, antioxidants (such as a hindered phenol-based, phosphorus, and sulfur-based ones), ultraviolet absorbers, organic pigment, inorganic pigment, pH regulators, crosslinking agents, compatibilizing agents, releasing agents (such as silicone- and fluorine-based ones), coupling agents, lubricants, insulating fillers (such as zinc oxide, barium sulfate, calcium sulfate, barium titanate, potassium titanate, strontium titanate, titanium oxide, magnesium oxide, magnesium hydroxide, aluminum hydroxide, talc, mica, clay, kaoline, hydrotalcite, silica, alumina, ferrite, calcium carbonate, barium carbonate, nickel carbonate, glass powder, quartz powder, glass fiber, alumina fiber, potassium titanate fiber, and fine particles of thermosetting resin), and electro-conductive fillers (such as carbon black, carbon fiber, electro-conductive titanium oxide, electro-conductive tin oxide, and electro-conductive mica). Such components may be used singly or in combination of two or more types.

### <Method for Manufacturing Base Layer>

The method for manufacturing the base layer a1 is not limited in particular. Molding methods appropriate for respective types of resins may be used. Examples include extrusion molding, inflation molding, blow molding, and centrifugal molding.

### (A-2) Formation of Surface Layer a2

The formation process of the surface layer a2 includes the following steps (A-2-1) to (A-2-3):

Step (A-2-1) of forming a coating film of the curable composition including the components (a) and (b) on the surface of the base layer a1 including the ionic liquid, fabricated as described above;
Step (A-2-2) of causing heteroaggregation of the components (a) and (b) in the layer of the curable composition with the component (e) migrated from the base layer a1, thereby forming heteroaggregates; and

### Step (A-2-3) of Curing the Layer of the Curable Composition to Form the Surface Layer a2.

Examples of the method for forming the coating film of the curable composition on the surface of the base layer a1 of the electrophotographic belt in the foregoing step (A-2-1) include dip coating, spray coating, flow coating, shower coating, roll coating, and spin coating.

In the foregoing step (A-2-2), during the period between immediately after the formation of the coating film of the curable composition and the volatilization of the solvent from the coating film, the ionic liquid included in the base layer a1 migrates, and the components (a) and (b) form heteroaggregates with the ionic liquid in the layer of the curable composition.

The curing of the coating film of the curable composition according to the foregoing step (A-2-3) can be performed, for example, by heat or irradiation of radiations, such as light and an electron beam.

Any active radiations that can provide energy capable of generating polymerization initiation species in the coating film of the curable composition may be used without particular limitation. Examples include a wide variety of radiations such as a rays, γ rays, X-rays, ultraviolet rays (UV), visible rays, and an electron beam. Of these, ultraviolet rays and an electron beam, particularly ultraviolet rays, are suitable in view of curing sensitivity and device availability.

### <<B>>

Another method for manufacturing the electrophotographic member illustrated in FIG. 1 will be described below.

### (B-1) Fabrication of Base Layer a1

The base layer a1 is fabricated in a manner similar to the foregoing (A-1). The base layer a1 does not need to contain the component (e).

### (B-2) Formation of Surface Layer a2

The formation process of the surface layer a2 includes the flowing steps (B-2-1) to (B-2-3):

Step (B-2-1) of forming a coating film of a curable composition containing the components (a), (b), and (e) on the surface of the base layer a1 fabricated in the foregoing (B-1);
Step (B-2-2) of drying the coating film and forming heteroaggregates of the components (a), (b), and (e); and
Step (B-2-3) of curing the coating film.

The descriptions of the foregoing steps (A-2-1) to (A-2-3) also apply to steps (B-2-1) to (B-2-3) described above.

### <<C>>

A method for manufacturing the electrophotographic member illustrated in FIG. 2, including the base layer a1, the elastic layer a3, and the surface layer a2 on the elastic layer a3, will be described.

### (C-1) Fabrication of Base Layer a1

The base layer a1 is fabricated in a manner similar to the foregoing (A-1). The base layer a1 does not need to contain the component (e).

### (C-2) Fabrication of Elastic Layer a3

### <Components of Elastic Layer>

The components of the elastic layer a3 are listed below.

### (g) Rubber Component:

A rubber component used to form the elastic layer a3 is not limited in particular, and various rubber compositions may be used. Specific examples include butadiene rubber, isopropylene rubber, nitrile rubber, chloroprene rubber, ethylene-propylene rubber, silicone rubber, and urethane rubber. Such rubbers may be used singly or in combination of two or more types. Of these, liquid silicone rubber are suitably used because it is important for the elastic layer a3 to have appropriately low hardness and sufficient resilience. In particular, addition reaction crosslinking liquid silicone rubber can be used for reasons of excellent productivity, for example, favorable workability, highly stability of dimension accuracy, and the occurrence of no reaction byproducts during the curing reaction.

### (e) Ionic Liquid:

The elastic layer a3 contains the ionic liquid so that the ionic liquid migrates into the coating film of the curable composition for forming the surface layer a2 in the drying process of the coating film formed on the surface of the elastic layer a3. The amount of the ionic liquid added to the rubber component can be appropriately adjusted according to the content of the inorganic oxide particles and the electro-conductive metal oxide particles in the surface layer a2. For example, the ionic liquid can be added as much as 0.01 parts or more and 10 parts or less by weight to 100 parts by weight of the rubber component according to the foregoing component (g).

In another method for forming the elastic layer a3 including the ionic liquid, an elastic layer including the rubber component is formed in advance. A liquid containing the ionic liquid is applied to the surface of the elastic layer on the side where the surface layer a2 is formed.

Various additives including non-electro-conductive fillers, plasticizers, and electro-conductive fillers may be mixed into the elastic layer a3 to such an extent that desired performance can be obtained. Examples of the non-electro-conductive fillers include diatomaceous earth, quartz powder, dry silica, wet silica, aluminosilicate, and calcium carbonate. Examples of the plasticizers include polydimethylsiloxane oil, diphenylsilanediol, trimethylsilanol, phthalic acid derivatives, and adipic acid derivatives. Examples of the electro-conductive fillers include electro-conductive agents having an electron conduction mechanism, such as carbon black, graphite, and electro-conductive metal oxides, and electro-conductive agents having an ionic conduction mechanism, such as alkali metal salts and quaternary ammonium salts.

The elastic layer a3 can have a thickness of 10 μm or more and 1000 μm or less.

### <Method for Manufacturing Elastic Layer>

The method for manufacturing the elastic layer a3 is not limited in particular, and molding methods suitable for respective resins may be used. Examples include cast molding and ring coat molding.

### (C-3) Formation of Surface Layer a2

The formation process of the surface layer a2 includes the following steps (C-3-1) to (C-3-3):

Step (C-3-1) of forming a coating film of a curable composition containing the components (a) and (b) on the surface of the elastic layer a3 including the ionic liquid, fabricated as described above;
Step (C-3-2) of causing heteroaggregation of the components (a) and (b) in the layer of the curable composition with the component (e) migrated from the elastic layer a3, thereby generating heteroaggregates; and
Step (C-3-3) of curing the layer of the curable composition to form the surface layer a2.

The descriptions of the foregoing steps (A-2-1) to (A-2-3) also apply to steps (C-3-1) to (C-3-3) described above.

### <<D>>

Another method for manufacturing the electrophotographic member illustrated in FIG. 2 will be described below.

### (D-1) Fabrication of Base Layer a1 and Elastic Layer a3

The base layer a1 and the elastic layer a3 are fabricated in a manner similar to the foregoing (C-1) and (C-2). The elastic layer a3 does not need to contain the component (e).

### (D-2) Formation of Surface Layer a2

The formation process of the surface layer a2 includes the following steps (D-2-1) to (D-2-3):

Step (D-2-1) of forming a coating film of a curable composition containing the components (a), (b), and (e) on the surface of the elastic layer a3 fabricated in the foregoing (D-1);
Step (D-2-2) of drying the coating film and forming heteroaggregates of the components (a), (b), and (e); and
Step (D-2-3) of curing the coating film.

The descriptions of the foregoing steps (A-2-1) to (A-2-3) also apply to steps (D-2-1) to (D-2-3) described above.

### <<Electrophotographic Apparatus>>

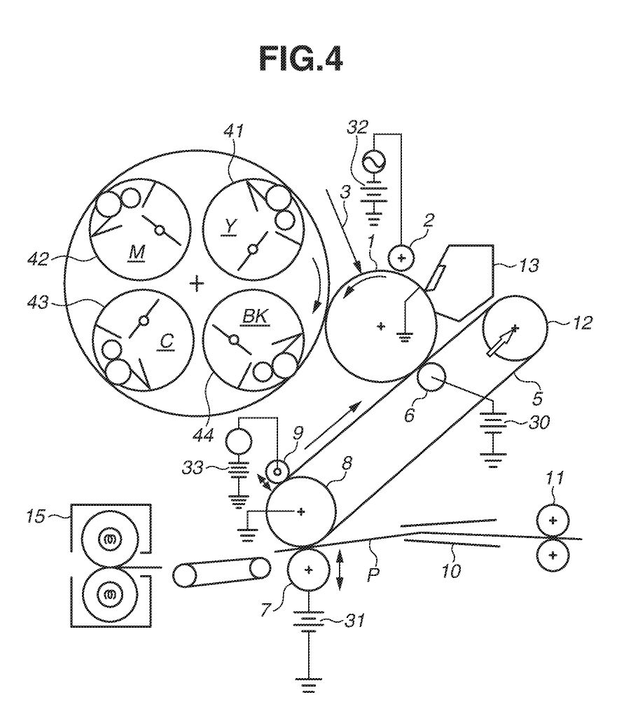

An example electrophotographic apparatus will be described. FIG. 4 is a sectional view illustrating a full color electrophotographic apparatus. In FIG. 4, an example embodiment of an electrophotographic belt is used as an intermediate transfer belt 5.

An electrophotographic photosensitive member 1 is a drum-shaped electrophotographic photosensitive member (hereinafter, referred to as a “photosensitive drum”) which is repeatedly used as a first image bearing member. The photosensitive drum 1 is driven to rotate in the direction of the arrow at a predetermined circumferential speed (process speed).

In the process of rotation, the photosensitive drum 1 is uniformly charged to a predetermined polarity and potential by a primary charger 2. A power supply 32 applies a desired bias to the primary charger 2. The photosensitive drum 1 is then subjected to image exposure 3 by an exposure unit, whereby an electrostatic latent image corresponding to a first color component image (for example, a yellow color component image) of the intended color image is formed. Examples of the exposure unit include a color separation and imaging exposure optical system of a color original image and a scanning exposure system. The scanner exposure system uses a laser scanner for outputting a laser beam that is modulated according to a time-series electrical digital pixel signal of image information.

The electrostatic latent image on the photosensitive drum 1 is then developed with yellow toner Y, which is first color toner, by a first developing device (yellow color developing device 41). Here, second to fourth developing devices (magenta color developing device 42, cyan color developing device 43, and black color developing device 44) are deactivated and do not act on the photosensitive drum 1. The first-color yellow toner image is not affected by any of the foregoing second to fourth developing devices.

The intermediate transfer belt 5 is driven to rotate in the direction of the arrow at the same circumferential speed as that of the photosensitive drum 1 by a driving roller 8 and a driven roller 12. When the yellow toner image on the photosensitive drum 1 passes through a nip portion between the photosensitive drum 1 and the intermediate transfer belt 5, the yellow toner image is transferred to an outer peripheral surface of the intermediate transfer belt 5 (primary transfer). The primary transfer is performed by a primary transfer bias which is applied to the intermediate transfer belt 5 from a power supply 30 via a primary transfer counter roller 6. After the transfer of the first-color yellow toner image to the intermediate transfer belt 5, the surface of the photosensitive drum 1 is cleaned by a cleaning device 13.

Subsequently, a second-color magenta toner image, a third-color cyan toner image, and a fourth-color black toner image are sequentially transferred onto the intermediate transfer belt 5 in a superposed manner, whereby a composite color toner image corresponding to the intended color image is formed.

A secondary transfer roller 7 is pivotally supported to correspond to and in parallel with the driving roller 8. The secondary transfer roller 7 is arranged to be separable from a lower surface portion of the intermediate transfer belt 5. During the primary transfer step of the first- to third-color toner images from the photosensitive drum 1 to the intermediate transfer belt 5, the secondary transfer roller 7 can be separated from the intermediate transfer belt 5.

The composite color toner image transferred to the intermediate transfer belt 5 is transferred to a transfer material P, which is a second image bearing member, in the following manner. Initially, the secondary transfer roller 7 is brought into contact with the intermediate transfer belt 5. The transfer material P is fed from a feed roller 11 to a contact nip between the intermediate transfer belt 5 and the secondary transfer roller 7 through a transfer material guide 10. A secondary transfer bias is then applied from a power supply 31 to the secondary transfer roller 7. By this secondary transfer bias, the composite color toner image is transferred from the intermediate transfer belt 5 to the transfer material P which is the secondary image bearing member (secondary transfer).

The transfer material P to which the composite color toner image is transferred is guided into a fixing device 15 for heating and fixing. After the image transfer to the transfer material P, an intermediate transfer belt cleaning roller 9 of a cleaning device is brought into contact with the intermediate transfer belt 5. A bias of opposite polarity to that of the photosensitive drum 1 is applied to the intermediate transfer belt cleaning roller 9 by a power supply 33. A charge of opposite polarity to that of the photosensitive drum 1 is thereby given to toner (transfer residual toner) that remains on the intermediate transfer belt 5 without being transferred to the transfer material P. The transfer residual tonner is electrostatically transferred to the photosensitive drum 1 at and near the nip portion between the intermediate transfer belt 5 and the photosensitive drum 1, whereby the intermediate transfer belt 5 is cleaned.

According to an aspect of the present disclosure, an electrophotographic member capable of maintaining stable quality regardless of the environment in forming the surface layer, and a method for manufacturing the electrophotographic member are provided. According to another aspect of the present disclosure, an electrophotographic image forming apparatus that can stably form a high-quality electrophotographic image is provided.

### EXAMPLES

An exemplary embodiment will be described in detail below by using Examples and Comparative Examples. The scope of the present invention is not limited thereto.

Table 1 shows details of material types used to manufacture the base layer a1 and the elastic layer a3 in the Examples and Comparative Examples. Table 2 shows details of material types used to manufacture the surface layer a2.

TABLE 1

| | Material | Trade name |
|---|---|---|
| Components | Polyethylene naphthalate | Trade name: |
| for forming | (PEN) | TR-8550, |
| base | | manufactured |
| layer/elastic | | by Teijin |
| layer | | Chemicals |
| | | Ltd. |
| | Polyether ester amide | Trade name: |
| | (PEEA) | PELE STAT |
| | | NC6321, |
| | | manufactured |
| | | by Sanyo |
| | | Chemical |
| | | Industries, |
| | | Ltd. |
| | Carbon black (CB1) | Trade name: |
| | | MA-100, |
| | | manufactured |
| | | by |
| | | Mitsubishi |
| | | Chemical |
| | | Corporation |
| | Carbon black (CB2) | Trade name: |
| | | DENKA BLACK, |
| | | manufactured |
| | | by Denka |
| | | Company |
| | | Limited |
| | Ionic liquid (e1) | Manufactured |
| | 1-Butyl-3-methyl- | by Toyo |
| | imidazolium | Gosei Co., |
| | hexafluorophosphate | Ltd |
| | Ionic liquid (e2) | Manufactured |
| | 1-ethyl-3-methylimidazolium | by Toyo |
| | bis(trifluoromethanesulfonyl) | Gosei Co., |
| | imide | Ltd |
| | Ionic liquid (e3) | Manufactured |
| | N,N,N-tributyl-N- | by 3M |
| | methylammonium | Company |
| | bis(trifluoromethanesulfonyl) | |
| | imide | |

TABLE 2

| Material type | | | |
|---|---|---|---|
| symbol | | Material | Trade name |
| (a) | 1 | Slurry of silica particles | “SNOWTEX |
| | | (30% by weight of silica | MEK-ST” |
| | | particle component) | manufactured |
| | | | by Nissan |
| | | | Chemical |
| | | | Industries, |
| | | | Ltd. |
| | 2 | Slurry of titania particles | “NanoTek |
| | | (15% by weight of titania | Slurry” |
| | | particle component) | manufactured |
| | | | by C. I. |
| | | | Kasei Co., |
| | | | Ltd. |
| | 3 | Slurry of yttrium oxide | “NanoTek |
| | | particles | Slurry” |
| | | (10% by weight of yttrium | manufactured |
| | | oxide particle component) | by C. I. |
| | | | Kasei Co., |
| | | | Ltd. |
| (b) | 1 | Slurry of zinc antimonate | “CELNAX CX- |
| | | particles | Z400K” |
| | | (40% by weight of zinc | manufactured |
| | | antimonate particle | by Nissan |
| | | component) | Chemical |
| | | | Industries, |
| | | | Ltd. |
| | 2 | Slurry of gallium-doped zinc | “GZOMIBK- |
| | | oxide particles | E12” |
| | | (25% by weight of gallium- | manufactured |
| | | doped zinc oxide particle | by C. I. |
| | | component) | Kasei Co., |
| | | | Ltd. |
| | 3 | Slurry of antimony-doped tin | “ATO(T-1)” |
| | | oxide particles | manufactured |
| | | (20% by weight of | antimony- by |
| | | doped tin oxide particle | Mitsubishi |
| | | component) | Materials |
| | | | Electronic |
| | | | Chemicals |
| | | | Co., Ltd. |
| (c) | 1 | Dipentaerythritol | “ARONIX M- |
| | | pentaacrylate and | 402” |
| | | dipentaerythritol | manufactured |
| | | hexaacrylate | by Toagosei |
| | | | Co., Ltd. |
| | 2 | Pentaerythritol triacrylate | “ARONIX M- |
| | | and pentaerythritol | 305” |
| | | tetraacrylate | manufactured |
| | | | by Toagosei |
| | | | Co., Ltd. |
| (d) | 1 | 2-Butanone | Manufactured |
| | | | by KISHIDA |
| | | | CHEMICAL |
| | | | Co., Ltd. |
| | 2 | 2-Methyl-3-pentanone | Manufactured |
| | | | by KISHIDA |
| | | | CHEMICAL |
| | | | Co., Ltd. |
| (e) | 1 | Ionic liquid (e1) | Manufactured |
| | | | by Toagosei |
| | | | Co., Ltd. |
| | 2 | Ionic liquid (e2) | Manufactured |
| | | | by Toagosei |
| | | | Co., Ltd. |
| | 3 | Ionic liquid (e3) | Manufactured |
| | | | by 3M |
| | | | Company |
| Alkali | 1 | Potassium perfluorobutane | “KFBS” |
| metal salt | | sulfonate | manufactured |
| | | | by |
| | | | Mitsubishi |
| | | | Materials |
| | | | Electronic |
| | | | Chemicals |
| | | | Co., Ltd. |
| | 2 | Lithium perfluorobutane | “LFBS” |
| | | sulfonate | manufactured |
| | | | by |
| | | | Mitsubishi |
| | | | Materials |
| | | | Electronic |
| | | | Chemicals |
| | | | Co., Ltd. |
| | 3 | Potassium | Manufactured |
| | | bis(trifluoromethanesulfonyl) | by |
| | | imide | Mitsubishi |
| | | | Materials |
| | | | Electronic |
| | | | Chemicals |
| | | | Co., Ltd. |

| | |
|---|---|
| Polymerization initiator | “IRGACURE |
| | 907” |
| | manufactured |
| | by BASF SE |
| Solvent soluble silicone surface | “BYK- |
| additive manufactured | Silclean |
| | 3700” |
| | by BYK |
| | Additives & |
| | Instruments |
| Resin (melamine-formaldehyde | “Epostar |
| condensate) particles | S12” |
| | manufactured |
| | by Nippon |
| | Shokubai |
| | Co., Ltd., |
| | particle |
| | diameters of |
| | 1 to 2 μm |

### Example 1

### Manufacture of Base Layer

Initially, the materials shown in the following Table 3, mixed in amounts shown in Table 3, were thermally melted and kneaded to prepare a thermoplastic resin composition by using biaxial extruder (trade name: TEX30α, manufactured by The Japan Steel Works, Ltd.). The thermal melting and kneading temperature was adjusted within a range of 260° C. or higher and 280° C. or lower. The thermal melting and kneading time was approximately 3 to 5 minutes. The resulting thermoplastic resin composition was formed into pellets and dried at a temperature of 140° C. for 6 hours. The dried pellets of the thermoplastic resin composition were then put into an injection molding machine (trade name: SE180D, manufactured by Sumitomo Heavy Industries, Ltd.). At a cylinder set temperature of 295° C., the thermoplastic resin composition was injection molded into a mold that was temperature-controlled to a temperature of 30° C., whereby a preform was fabricated. The resulting preform had a test tube shape with an outer diameter of 20 mm, an inner diameter of 18 mm, and a length of 150 mm.

TABLE 3

| | Mixing amount |
|---|---|
| Material | (parts by weight) |
| PEN | 84 |
| PEEA | 15 |
| CB1 | 1 |

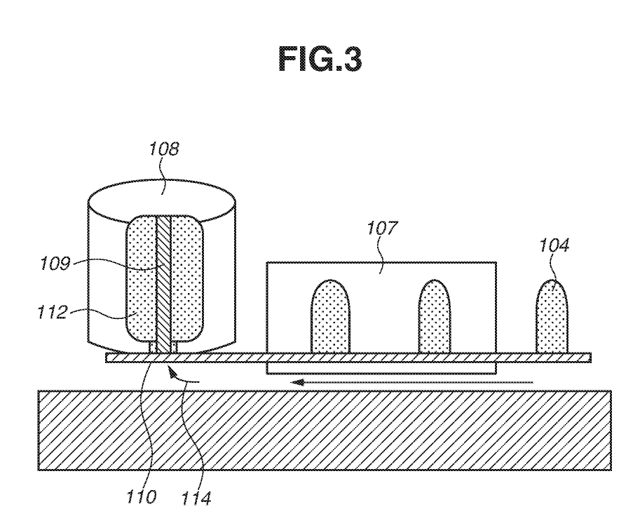

Next, the foregoing preform was biaxially stretched by using a biaxial stretching machine (stretch blow molding machine) illustrated in FIG. 3. Before the biaxial stretching, a preform 104 was put in a heating machine 107 including noncontact heaters (not illustrated) for heating the outer and inner walls of the preform 104. The preform 104 was heated by the heaters to an outer surface temperature of 120° C.

The heated preform 104 was then put in a blow mold 108 which was maintained at a mold temperature of 30° C., and axially stretched by using a stretching rod 109. At the same time, air 114 that was temperature-controlled to a temperature of 23° C. was introduced into the interior of the preform 104 from a blow air injection portion 110 to radially stretch the preform 104. In such a manner, a bottle-shaped molded article 112 was obtained.

The body section of the obtained bottle-shaped molded article 112 was then cut into a base layer of a seamless electro-conductive belt. The resulting base layer of a seamless electro-conductive belt had a thickness of 70 μm. This base layer will be referred to as base layer No. 1.

### <<Fabrication of Electrophotographic Belt No. 1-1>>

### [Formation of Surface Layer]

The materials listed in Table 4 were mixed to prepare a curable composition No. 1.

TABLE 4

| | Mixing amount |
|---|---|
| Material type symbol | (parts by weight) |
| (a)1 | 8.3 |
| (b)1 | 75 |
| (c)1 | 57 |
| (c)2 | 38 |
| (d)1 | 200 |
| (d)2 | 140 |
| (e)1 | 1 |
| Polymerization initiator | 5 |
| Leveling agent | 0.5 |

In an environment with a temperature of 23° C., a relative humidity of 50%, and an amount of absolute humidity of 10.3 g/m³ (hereinafter, may be referred to as a normal-temperature normal-humidity (NN) environment), the base layer No. 1 was fitted to the outer periphery of a cylindrical mold, and sealed at ends. The resultant was immersed into a container filled with the curable composition No. 1, with the mold and all, and pulled up so that a relative speed between the liquid surface of the curable composition No. 1 and the base layer No. 1 was constant, whereby a coating film of the curable composition No. 1 was formed on the surface of the base layer No. 1. The pulling speed (relative speed between the liquid surface of the curable composition No. 1 and the base layer No. 1) and the proportion of the solvent in the curable composition No. 1 can be adjusted according to the intended thickness.

In the present Example, the pulling speed was adjusted to 10 to 50 mm/sec so that the surface layer had a thickness of 3 μm. After the formation of the coating film, the resultant was dried in the NN environment for one minute.

Using a UV irradiation machine (trade name: UE06/81-3, manufactured by EYE GRAPHICS CO., LTD.), the dried coating film was irradiated with UV to a cumulative amount of light of 600 mJ/cm². The coating film was thereby cured to obtain an electrophotographic belt No. 1-1 having an endless belt shape. The surface layer was observed in a cross section under an electron microscope and found to have a thickness of 3 μm.

### <<Fabrication of Electrophotographic Belts Nos. 1-2 and 1-3>>

To evaluate the environment for forming the surface layer, i.e., dependence on the absolute humidity, electrophotographic belts Nos. 1-2 and 1-3 were fabricated in a manner similar to the fabrication of the electrophotographic belt No. 1-1, except that the electrophotographic belts Nos. 1-2 and 1-3 were manufactured in an environment with a temperature of 15° C., a relative humidity of 10%, and an amount of absolute humidity of 1.3 g/m³ (hereinafter, may be referred to as a low-temperature low-humidity (LL) environment) and in an environment with a temperature of 30° C., a relative humidity of 80%, and an amount of absolute humidity of 24.3 g/m³ (hereinafter, may be referred to as a high-temperature high-humidity (HH) environment), respectively.

### [Evaluation]

By using the electrophotographic belts Nos. 1-1 to 1-3, the following evaluations 1-1, 1-2, and 2 to 4 were conducted.

### (Evaluation 1-1: Roughness, Ten-Point Average Roughness Rzjis)

For each of the electrophotographic belts Nos. 1-1 to 1-3, the ten-point average roughness (Rzjis) on the outer surface of the surface layer of was measured. The measurement was performed according to Japanese Industrial Standards (JIS) B 0601 (1994). A surface roughness measuring instrument (trade name: Surfcorder “SE3500,” manufactured by Kosaka Laboratory Ltd.) was used for the measurement. The measurement condition included a scanning distance of 1.0 mm, a cutoff value of 0.08 mm, and a probe scanning speed of 0.05 mm/sec.

### (Evaluation 1-2: Measurement of Difference (RE) in Surface Roughness)

A difference “RE” between the surface roughness of the outer surface of the surface layer of the electrophotographic belt No. 1-3 of which the surface layer was formed in the HH environment and that of the outer surface of the electrophotographic belt No. 1-2 of which the surface layer was formed in the LL environment was determined. If the “RE” is 0.00 μm or more and 0.10 μm or less or so, the surface roughness can be determined to have no or little dependence on the environment (absolute humidity).

### (Evaluation 2: Adhesiveness to Other Members)

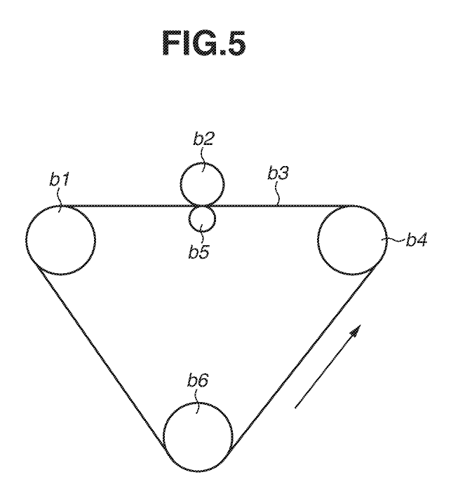

Using the electrophotographic belt No. 1-1 of which the surface layer was formed in the NN environment, adhesiveness to the photosensitive drum of a full color electrophotographic apparatus (trade name: LBP-5200, manufactured by Canon Inc.) was measured by using a jig illustrated in FIG. 5.

In FIG. 5, an electrophotographic belt b3 is stretched across a driving roller b1, a driven roller b4, and a tension roller b6. A motor and a torque meter (neither of which is illustrated) are attached to the driving roller b1. The tension roller b6 applies tension to the electrophotographic belt b3. The photosensitive drum and a transfer roller mounted on LBP-5200 are used as a photosensitive drum b2 and a backup roller b5.

Initially, the electrophotographic belt b3 was rotated at 180 mm/sec with the photosensitive drum b2 kept out of contact, and the torque value was measured. This value will be referred to as “TQ1.”

Next, the electrophotographic belt b3 was made contact with the photosensitive drum b2 with a load of 700 gf. The maximum value of torque in such a state that the electrophotographic belt b3 was rotated at 180 mm/sec was measured. This value will be referred to as “TQ2.” A difference “TQ” between “TQ2” and “TQ1” was used as an index for evaluating the adhesiveness between the electrophotographic belt and the photosensitive drum.

“TQ1” and “TQ2” of the electrophotographic belt No. 1-1 were measured immediately after manufacturing. The calculated value of “TQ” is referred to as “TQ(initial).”

The electrophotographic belt No. 1-1 was mounted as the intermediate transfer belt of the foregoing full color electrophotographic image forming apparatus. After formation of 50000 electrophotographic images (referred to as “after endurance”), the electrophotographic belt No. 1-1 was taken out of the full color electrophotographic image forming apparatus, and “TQ1” and “TQ2” were measured. The calculated value is referred to as “TQ(after endurance).”

### (Evaluation 3: Average Primary Particle Diameter)

An average primary particle diameter of the inorganic oxide particles and the electro-conductive metal oxide particles in the surface layer was determined by the following method.

The surface layer of the electrophotographic belt No. 1-1 was cut with a microtome to prepare a sample of the surface layer. This sample was embedded in epoxy resin. After curing, the epoxy resin was cut with a microtome to form a strip in which a cross section of the sample embedded in the epoxy resin in the thickness direction of the surface layer was exposed.

Next, by using a field emission-type scanning transmission electron microscope (STEM) (JEM-2100FX, manufactured by JEOL Ltd.), the strip was observed under an acceleration voltage of 200 kV, a beam diameter of 1 nm, and a magnification of 400000 times.

At the same time, an elemental mapping analysis was performed by using an accompanying energy dispersive spectroscopy using X-rays (EDX) (JED-2300T, manufactured by JEOL Ltd.). The inorganic oxide particles and the electro-conductive metal oxide particles constituting the heteroaggregates in the cross-sectional picture were thereby clearly distinguished.

In the picture, the maximum and minimum lengths of a projection image of an inorganic oxide particle constituting one of the heteroaggregates were summed and divided by 2 to determine the obtained value as a primary particle diameter of the inorganic oxide particle. Such an operation was performed on 100 inorganic oxide particles constituting the heteroaggregates. An arithmetic average of the resulting primary particle diameters was determined as an average primary particle diameter of the inorganic oxide particles.

Similarly, for the electro-conductive metal oxide particles constituting the heteroaggregates, the respective primary particle diameters of 100 electro-conductive metal oxide particles constituting the heteroaggregates were determined. An arithmetic average of the primary particle diameters was then determined as the average primary particle diameter of the electro-conductive metal oxide particles.

### (Evaluation 4: Singular Protrusions (Particles) on Surface of Surface Layer)

The entire outer surface of the surface layer of the electrophotographic belt No. 1-1 was visually observed for singular points (particles). If any, the position of the singular point was identified, and the singular point was observed under an optical microscope with a magnification of 200 times. The number of protrusions having a major length (diameter) of 20 μm or more on the outer surface of the surface layer was counted. If the number of protrusions is zero to one or so, images obtained by using such an electrophotographic belt are unlikely to have a large image defect.

### Examples 2 to 7 and 9 to 11, Comparative Examples 1 to 8 and 10

### (1) Fabrication of Base Layers 2 to 4

Compositions Nos. 2 to 4 for forming a base layer, having composition shown in Table 5, were prepared. Base layers Nos. 2 to 4 were fabricated in a manner similar to the fabrication of the base layer according to Example 1, except the use of the compositions Nos. 2 to 4.

TABLE 5

| | Composition No. for | | |
|---|---|---|---|
| Material type | forming base layer | | |
| symbol | 2 | 3 | 4 |
| PEN | 82 | 82 | 82 |
| PEEA | 15 | 15 | 15 |
| CB1 | 1 | 1 | 1 |
| PEEK | — | — | — |
| CB2 | — | — | — |
| (e)1 | 2 | — | — |
| (e)2 | — | 2 | — |
| (e)3 | — | — | 2 |

Unit: parts by weight

### (2) Preparation of Curable Compositions Nos. 2 to 16 for Forming Surface Layer

Curable compositions Nos. 2 to 16 for forming a surface layer, having composition shown in Table 6, were prepared.

TABLE 6

| | Curable composition No. for forming | | | | | | | | | | | | | | |
|---|---|---|---|---|---|---|---|---|---|---|---|---|---|---|---|
| Material type | surface layer | | | | | | | | | | | | | | |
| symbol | 2 | 3 | 4 | 5 | 6 | 7 | 8 | 9 | 10 | 11 | 12 | 13 | 14 | 15 | 16 |
| (a)1 | 8.3 | 8.3 | — | — | 8.3 | 8.3 | 8.3 | 8.3 | 8.3 | 8.3 | — | — | 8.3 | 8.3 | — |
| (a)2 | — | — | 8.3 | — | — | — | — | — | — | — | 8.3 | — | — | — | — |
| (a)3 | — | — | — | 8.3 | — | — | — | — | — | — | — | 8.3 | — | — | — |
| (b)1 | 75 | 75 | 75 | 75 | — | — | 75 | 75 | 75 | 75 | 75 | 75 | — | — | — |
| (b)2 | — | — | — | — | 75 | — | — | — | — | — | — | — | 75 | — | — |
| (b)3 | — | — | — | — | — | 75 | — | — | — | — | — | — | — | 75 | — |
| (c)1 | 57 | 57 | 57 | 57 | 57 | 57 | 57 | 57 | 57 | 57 | 57 | 57 | 57 | 57 | 57 |
| (c)2 | 38 | 38 | 38 | 38 | 38 | 38 | 38 | 38 | 38 | 38 | 38 | 38 | 38 | 38 | 38 |
| (d)1 | 200 | 200 | 200 | 200 | 200 | 200 | 200 | 200 | 200 | 200 | 200 | 200 | 200 | 200 | 200 |
| (d)2 | 140 | 140 | 140 | 140 | 140 | 140 | 140 | 140 | 140 | 140 | 140 | 140 | 140 | 140 | 140 |
| (e)1 | — | — | 1 | 1 | 1 | 1 | — | — | — | — | — | — | — | — | — |
| (e)2 | 1 | — | — | — | — | — | — | — | — | — | — | — | — | — | — |
| (e)3 | — | 1 | — | — | — | — | — | — | — | — | — | — | — | — | — |
| Alkali metal | — | — | — | — | — | — | — | 1 | — | — | 1 | 1 | 1 | 1 | — |
| salt (1) | | | | | | | | | | | | | | | |
| Alkali metal | — | — | — | — | — | — | — | — | 1 | — | — | — | — | — | — |
| salt (2) | | | | | | | | | | | | | | | |
| Alkali metal | — | — | — | — | — | — | — | — | — | 1 | — | — | — | — | — |
| salt (3) | | | | | | | | | | | | | | | |
| Polymerization | 5 | 5 | 5 | 5 | 5 | 5 | 5 | 5 | 5 | 5 | 5 | 5 | 5 | 5 | 5 |
| initiator | | | | | | | | | | | | | | | |
| Leveling agent | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Resin particles | — | — | — | — | — | — | — | — | — | — | — | — | — | — | 5 |

Unit: parts by weight

(3) Electrophotographic belts according to Examples 2 to 7 and 9 to 11 and Comparative Examples 1 to 8 and 10 were fabricated in a manner similar to Example 1, except that the composition No. for forming a base layer and the curable composition No. for forming a surface layer were combined as shown in Table 7. The resulting electrophotographic belts were evaluated in a manner similar to Example 1.

TABLE 7

| | Examples | | | | | | | | | |
|---|---|---|---|---|---|---|---|---|---|---|
| | 1 | 2 | 3 | 4 | 5 | 6 | 7 | 9 | 10 | 11 |
| Composition No. for | 1 | 1 | 1 | 1 | 1 | 1 | 1 | 2 | 3 | 4 |
| forming base layer | | | | | | | | | | |
| Curable composition | 1 | 2 | 3 | 4 | 5 | 6 | 7 | 8 | 8 | 8 |
| No. for forming | | | | | | | | | | |
| surface layer | | | | | | | | | | |
| Component (e) in | No | No | No | No | No | No | No | Yes | Yes | Yes |
| base layer | | | | | | | | | | |
| Component (e) in | Yes | Yes | Yes | Yes | Yes | Yes | Yes | No | No | No |
| curable composition | | | | | | | | | | |
| Alkali metal salt in | No | No | No | No | No | No | No | No | No | No |
| curable composition | | | | | | | | | | |

| | Comparative Examples | | | | | | | | |
|---|---|---|---|---|---|---|---|---|---|
| | 1 | 2 | 3 | 4 | 5 | 6 | 7 | 8 | 10 |
| Composition No. for | 1 | 1 | 1 | 1 | 1 | 1 | 1 | 1 | 1 |
| forming base layer | | | | | | | | | |
| Curable composition | 8 | 9 | 10 | 11 | 12 | 13 | 14 | 15 | 16 |
| No. for forming | | | | | | | | | |
| surface layer | | | | | | | | | |
| Component (e) in | No | No | No | No | No | No | No | No | No |
| base layer | | | | | | | | | |
| Component (e) in | No | No | No | No | No | No | No | No | No |
| curable composition | | | | | | | | | |
| Alkali metal salt in | No | Yes | Yes | Yes | Yes | Yes | Yes | Yes | No |
| curable composition | | | | | | | | | |

### Example 8

### Fabrication of Base Layer No. 5

By using a biaxial extruder (trade name: TEX30α, manufactured by The Japan Steel Works, Ltd.), the base layer forming composition No. 5 shown in Table 8 was thermally melted and kneaded to prepare a thermoplastic resin composition. The thermal melting and kneading temperature was adjusted within the range of 350° C. or higher and not higher than 380° C. The resulting thermoplastic resin composition was formed into pellets.

TABLE 8

| Material | Composition No. for |
|---|---|
| type | forming base layer 5 |
| PEEK | 81 |
| CB2 | 19 |

Next, the pellets of the thermoplastic resin composition were put into a single screw extruder (trade name: GT40, manufactured by Research Laboratory of Plastics Technology Co., Ltd.). The pellets were melted and extruded with an annular die, and cut into a base layer of a seamless electrophotographic belt. The resulting base layer of an electrophotographic belt had a thickness of 70 μm. This base layer is referred to as base layer No. 5.

### [Formation of Surface Layer]

A surface layer according to the curable composition No. 1 was formed in a manner similar to Example 1 except the use of the base layer No. 5. The resulting electrophotographic belt was evaluated in a manner similar to Example 1.

### Example 12

A cylindrical holding mold was fitted into the inner periphery of the base layer No. 5 according to Example 8. A cylindrical outer mold was put over the outer periphery of the base layer No. 5 with a clearance of 300 μm from the surface of the base layer No. 5. A liquid silicone rubber mixture No. 1 was injected into the gap between the outer mold and the surface of the base layer No. 5.

Details of the liquid silicone rubber mixture No. 1 are described below.

Ten parts by weight of CB2 was added to 90 parts by weight of silicone-based polymer (molecular weight Mw=100000, manufactured by Dow Corning Toray Co., Ltd.) and mixed in a planetary mixer for 30 minutes to obtain a silicone rubber base material.

For molding, the following liquids A and B mixed in a ratio of 1:1 by weight were used.

The liquid A was obtained by adding and mixing 0.02 parts by weight of an isopropyl alcohol solution of platinic chloride (platinum content of 3% by weight) into 100 parts by weight of the foregoing silicone rubber base material. The liquid B was obtained by adding and mixing 1.5 parts by weight of organohydrogen polysiloxane (with a viscosity of 10 cps, SiH content of 1% by weight, manufactured by Dow Corning Toray Co., Ltd.) into 100 parts by weight of the foregoing silicone rubber base material.

After primary curing in an oven at a temperature of 200° C. for 30 minutes, the cylindrical outer mold was removed, and secondary curing was further performed at 200° C. for 4 hours. As a result, a 300-μm-thick elastic layer No. 1 containing silicone rubber was formed on the base layer No. 5.

Next, the base layer No. 5 on which the elastic layer No. 1 was formed was fitted onto the outer periphery of a cylindrical mold, and a surface layer according to the curable composition No. 1 was formed on the outer surface of the elastic layer No. 1 in a manner similar to Example 1. The resulting electrophotographic belt was evaluated in a manner similar to Example 1.

### Example 13

In Example 13, an elastic layer No. 2 was formed on the base layer No. 5 in a manner similar to Example 12 except that the liquid silicone rubber mixture No. 1 was replaced with a liquid silicone rubber mixture No. 2.

Details of the liquid silicone rubber mixture No. 2 are described below.

Ten parts by weight of CB2 and one part by weight of (e)1 were added to 80 parts by weight of silicone-based polymer (molecular weight Mw=100000, manufactured by Dow Corning Torey Co., Ltd.) and mixed in a planetary mixer for 30 minutes to obtain a silicone rubber base material.

For molding, the following liquids A and B mixed in a ratio of 1:1 by weight were used.

The liquid A was obtained by adding and mixing 0.02 parts by weight of an isopropyl alcohol solution of platinic chloride (platinum content of 3% by weight) into 100 parts by weight of the foregoing silicone rubber base material. The liquid B was obtained by adding and mixing 1.5 parts by weight of organohydrogen polysiloxane (with a viscosity of 10 cps, SiH content of 1% by weight, manufactured by Dow Corning Toray Co., Ltd.) into 100 parts by weight of the foregoing silicone rubber base material.

Next, the base layer No. 5 on which the elastic layer No. 2 was formed was fitted onto the outer periphery of a cylindrical mold, and a surface layer according to the curable composition No. 8 was formed on the outer surface of the elastic layer No. 2 in a manner similar to Example 1. The resulting electrophotographic belt was evaluated in a manner similar to Example 1.

### Comparative Example 9

An electrophotographic belt was fabricated and evaluated in a manner similar to Example 12 except that the curable composition No. 9 was used to form the surface layer.

### <Evaluation Result>

Tables 9 and 10 show the evaluation results of the electrophotographic belts according to Examples 1 to 13 and Comparative Examples 1 to 10.

TABLE 9

| Evaluation | | | Examples | | | | | | | | | | | | |
|---|---|---|---|---|---|---|---|---|---|---|---|---|---|---|---|
| item | Unit | | 1 | 2 | 3 | 4 | 5 | 6 | 7 | 8 | 9 | 10 | 11 | 12 | 13 |
| Rzjis | (μm) | *1 | 0.52 | 0.61 | 0.48 | 0.55 | 0.52 | 0.56 | 0.48 | 0.49 | 0.51 | 0.58 | 0.48 | 0.54 | 0.49 |
| | | *2 | 0.18 | 0.56 | 0.44 | 0.52 | 0.48 | 0.51 | 0.44 | 0.45 | 0.47 | 0.54 | 0.44 | 0.50 | 0.44 |
| | | *3 | 0.56 | 0.65 | 0.52 | 0.59 | 0.56 | 0.60 | 0.51 | 0.52 | 0.56 | 0.62 | 0.52 | 0.58 | 0.53 |
| RE | (μm) | | 0.08 | 0.09 | 0.08 | 0.07 | 0.08 | 0.09 | 0.07 | 0.07 | 0.09 | 0.08 | 0.08 | 0.08 | 0.09 |
| TQ | (N · m) | | 0.05 | 0.05 | 0.06 | 0.05 | 0.05 | 0.05 | 0.06 | 0.06 | 0.05 | 0.04 | 0.05 | 0.06 | 0.06 |
| (initial) | | | | | | | | | | | | | | | |
| TQ(after | (N · m) | | 0.07 | 0.07 | 0.08 | 0.08 | 0.07 | 0.07 | 0.08 | 0.08 | 0.08 | 0.07 | 0.06 | 0.08 | 0.08 |
| endurance) | | | | | | | | | | | | | | | |
| Average | (nm) | | 20 | 21 | 20 | 16 | 20 | 20 | 21 | 20 | 20 | 19 | 18 | 21 | 20 |
| primary | | | | | | | | | | | | | | | |
| particle | | | | | | | | | | | | | | | |
| diameter of | | | | | | | | | | | | | | | |
| component | | | | | | | | | | | | | | | |
| (a) | | | | | | | | | | | | | | | |
| Average | (nm) | | 21 | 20 | 21 | 21 | 19 | 20 | 19 | 19 | 20 | 21 | 20 | 21 | 19 |
| primary | | | | | | | | | | | | | | | |
| particle | | | | | | | | | | | | | | | |
| diameter of | | | | | | | | | | | | | | | |
| component | | | | | | | | | | | | | | | |
| (b) | | | | | | | | | | | | | | | |
| Number of | (pcs) | | 0 | 1 | 0 | 0 | 1 | 0 | 0 | 1 | 0 | 0 | 1 | 1 | 0 |
| singular | | | | | | | | | | | | | | | |
| points | | | | | | | | | | | | | | | |
| (particles) | | | | | | | | | | | | | | | |

*1: Electrophotographic belt manufactured in NN environment
*2: Electrophotographic belt manufactured in LL environment
*3: Electrophotographic belt manufactured in HH environment

TABLE 10

| | | | Comparative Examples | | | | | | | | | |
|---|---|---|---|---|---|---|---|---|---|---|---|---|
| Evaluation item | Unit | | 1 | 2 | 3 | 4 | 5 | 6 | 7 | 8 | 9 | 10 |
| Rzjis | (μm) | *1 | 0.12 | 0.56 | 0.55 | 0.48 | 0.56 | 0.49 | 0.54 | 0.57 | 0.52 | 0.55 |
| | | *2 | 0.08 | 0.38 | 0.40 | 0.32 | 0.41 | 0.34 | 0.40 | 0.43 | 0.36 | 0.48 |
| | | *3 | 0.14 | 0.62 | 0.69 | 0.63 | 0.71 | 0.66 | 0.68 | 0.71 | 0.70 | 0.62 |
| RE | (μm) | | 0.06 | 0.34 | 0.29 | 0.31 | 0.3 | 0.32 | 0.28 | 0.28 | 0.34 | 0.14 |
| TQ(initial) | (N · m) | | 0.4 | — | — | — | — | — | — | — | — | 0.05 |
| TQ(after | (N · m) | | 0.55 | — | — | — | — | — | — | — | — | 0.07 |
| endurance) | | | | | | | | | | | | |
| Average primary | (nm) | | 21 | 20 | 20 | 21 | 20 | 20 | 20 | 21 | 21 | — |
| particle diameter | | | | | | | | | | | | |
| of component (a) | | | | | | | | | | | | |
| Average primary | (nm) | | 20 | 19 | 20 | 19 | 20 | 19 | 20 | 19 | 20 | — |
| particle diameter | | | | | | | | | | | | |
| of component (b) | | | | | | | | | | | | |
| Number of | (pcs) | | 0 | 1 | 0 | 0 | 1 | 1 | 0 | 0 | 1 | 85 |
| singular points | | | | | | | | | | | | |
| (particles) | | | | | | | | | | | | |

*1: Electrophotographic belt manufactured in NN environment
*2: Electrophotographic belt manufactured in LL environment
*3: Electrophotographic belt manufactured in HH environment

### Examples 1 to 8 and 12

In the electrophotographic belts according to Examples 1 to 8 and 12, heteroaggregates were formed by the components (a), (b), and (e) in the curable compositions. Differences in the surface roughness between the outer surfaces of the surface layers formed at different humidity levels were extremely small. [Example 9 to 11 and 13]

In the electrophotographic belts according to Examples 9 to 11 and 13, heteroaggregates were formed by the component (e) included in the base layer or elastic layer and the components (a) and (b) in the curable compositions. Differences in the surface roughness between the outer surfaces of the surface layers formed at different humidity levels were extremely small.

### Comparative Example 1

Since the curing composition for forming the surface layer did not contain any of the alkali metal salts or the component (e), heteroaggregates were not formed in the process of forming the surface layer. A predetermined roughness was therefore not formed on the surface of the electrophotographic belt according to the present Comparative Example. As a result, the electrophotographic belt according to the present Comparative Example showed high adhesiveness to other members.

### Comparative Examples 2 to 9

In the group of electrophotographic belts according to Comparative Examples 2 to 9, alkali metal salts were used as a component for forming heteroaggregates, instead of ionic liquid. The surface roughness resulting from the heteroaggregates therefore varied greatly depending on the absolute humidity of the atmosphere for forming the surface layers. Evaluation 2 was not performed on the group of electrophotographic belts according to Comparative Examples 2 to 9 because the dependence of the surface roughness on the absolute humidity was observed from the results of evaluations 1-1 and 1-2.

### Comparative Example 10

Since the electrophotographic belt according to the present Comparative Example was formed by adding organic resin fine particles having particle diameters of 1 to 2 μm to the curable composition, a predetermined roughness was formed on the surface. To achieve the predetermined roughness, particles having large particle diameters needed to be used for the surface roughening. A lot of protrusions (particles) were therefore observed on the surface of the electrophotographic belt according to the present Comparative Example. As a result, a large number of spot-like image defects occurred in an electrophotographic image that was formed by using an image forming apparatus equipped with the electrophotographic belt according to the present Comparative Example.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-241121, filed Dec. 10, 2015, which is hereby incorporated by reference herein in its entirety.

What is claimed is:

1. An electrophotographic member comprising a base layer and a surface layer,
wherein the surface layer contains a heteroaggregate of:
inorganic oxide particles,
electro-conductive metal oxide particles different from the inorganic oxide particles, and
an ionic liquid.

2. The electrophotographic member according to claim 1, wherein a surface of the electrophotographic member has a ten-point average roughness of 0.3 μm or more and 0.7 μm or less.

3. The electrophotographic member according to claim 1, wherein the inorganic oxide particles have an average primary particle diameter of 10 nm or more and 30 nm or less, and the electro-conductive metal oxide particles have an average primary particle diameter of 5 nm or more and 40 nm or less.

4. The electrophotographic member according to claim 1, wherein the inorganic oxide particles are silica particles, and the electro-conductive metal oxide particles are zinc antimonate particles.

5. The electrophotographic member according to claim 1, wherein a surface of the surface layer includes a protrusion derived from the heteroaggregate.

6. A method for manufacturing an electrophotographic member, the electrophotographic member including:
a base layer and a surface layer on the base layer; or
a base layer, an elastic layer on the base layer, and a surface layer on the elastic layer, the method comprising:
forming a layer of a curable composition on the base layer including an ionic liquid or forming the layer of the curable composition on the elastic layer including the ionic liquid, the curable composition including inorganic oxide particles and electro-conductive metal oxide particles different from the inorganic oxide particles;
causing heteroaggregation of the inorganic oxide particles, the electro-conductive metal oxide particles, and the ionic liquid in the layer of the curable composition; and
curing the layer of the curable composition to form the surface layer.

7. The method for manufacturing an electrophotographic member according to claim 6, wherein the inorganic oxide particles are alkyl-modified, and the electro-conductive metal oxide particles are treated with alkylamine.

8. The method for manufacturing an electrophotographic member according to claim 6, wherein the inorganic oxide particles have an average primary particle diameter of 10 nm or more and 30 nm or less, and the electro-conductive metal oxide particles have an average primary particle diameter of 5 nm or more and 40 nm or less.

9. The method for manufacturing an electrophotographic member according to claim 6, wherein the inorganic oxide particles are silica particles, and the electro-conductive metal oxide particles are zinc antimonate particles.

10. A method for manufacturing an electrophotographic member including a base layer and a surface layer, the method comprising:
causing heteroaggregation of inorganic oxide particles, electro-conductive metal oxide particles different from the inorganic oxide particles, and an ionic liquid in a curable composition, the curable composition including the inorganic oxide particles, the electro-conductive metal oxide particles, and the ionic liquid; and
curing a layer of the curable composition.

11. An electrophotographic apparatus comprising:
an electrophotographic photosensitive member; and
a transfer unit configured to transfer a toner image formed on the electrophotographic photosensitive member to a transfer material,
wherein the transfer unit includes an electrophotographic member as an intermediate transfer belt,
wherein the electrophotographic member includes a base layer and a surface layer, and
wherein the surface layer contains a heteroaggregate of:
inorganic oxide particles,
electro-conductive metal oxide particles different from the inorganic oxide particles, and
an ionic liquid.
